(19) United States
(12) Patent Application Publication
(10) Pub. No.: US 2007/0005622 A1
(43) Pub. Date: Jan. 4, 2007

(54) Method and apparatus for lazy construction of XML documents

(75) Inventors: Rohit C. Fernandes, Ithaca, NY (US); Mukund Raghavachari, Baldwin Place, NY (US)

Correspondence Address: MICHAEL J. BUCHENHORNER, 8540 S.W. 83 STREET, MIAMI, FL, 33143, US

(73) Assignee: International Business Machines Corporation

(21) Appl. No.: 11/169,474

(22) Filed: Jun. 29, 2005

(51) Int. Cl. G06F 7/00

(52) U.S. Cl. 707/101

(57) ABSTRACT

A method, information processing system, and computer readable medium for improved representation of hierarchical documents, particularly a document encoded in Extended Markup Language (XML). The method loads a hierarchical document and stores into an addressable data structure such as a byte array. It then expands the addressable data structure lazily in response to navigations requested by a client. Nodes requested by the client are materialized, that is, they are created in memory, whereas other nodes are left unmaterialized in byte form. The method reduces the memory footprint of an XML document, as well as, improves query evaluation time and serialization time.

### FIELD OF THE INVENTION

The invention disclosed broadly relates to the field of information handling systems and more particularly relates to the field of representing Extensible Markup Language (XML) documents in memory.

### BACKGROUND OF THE INVENTION

“Extensible Markup Language” (XML) is a textual notation for a class of data objects called “XML Documents” and partially describes a class of computer programs processing them. A characteristic of XML documents is that they use a hierarchical structure to organize information within the documents. This hierarchical structure may be represented using a rooted-tree data structure with nodes representing the “elements” of the XML document. Element nodes may have a tag name, may be associated with named attributes, and may have relationships to other nodes in the tree, where such relationships may refer to “parent” and “child” nodes. In addition, element nodes may contain data in various forms (specifically text, comments, and special “processing instructions”).

XML Document Trees

An XML document can be represented as a labeled tree whose nodes represent the structural components of the document—elements, text, attributes, comments, and processing instructions. Element and attribute nodes have labels derived from the corresponding tags in the document and there may be more than one node in the document with the same label. Parent-child edges in the tree represent the inclusion of the child component in its parent element, where the scope of an element is bounded by its start and end tags. The tree corresponding to an XML document is rooted at a virtual element, called the root, which represents the document itself. Hereinafter, XML documents will be discussed in terms of their tree representations. One can define an arbitrary order on the nodes of a tree. One such order might be based on a left-to-right depth-first traversal of the tree, which, for a tree representation of an XML document, corresponds to the document order. The memory footprint of an XML document can be large. XML processors may not be able to handle large documents due to the memory requirement of storing the entire document. As a result, in processing XML, reducing the memory overhead of an XML document is of great importance.

XPath

“XML Path Language” (XPath) is a query language for creating an expression that selects nodes of data from an XML document. XPath is used to address XML data using path notation to navigate through the hierarchical structure of an XML document. XPath queries allow applications to determine if a given node matches a pattern, including patterns involving its location in the XML document hierarchy.

XPath has been widely accepted in many environments, especially in database environments. Given the importance of XPath as a mechanism for querying and navigating data, it is important that the evaluation of XPath expressions on XML documents be as efficient as possible.

XML Processing

In traditional XML processing, a tree representation of an XML document that is to be processed is built in memory. When the document is large, this construction of the tree representation, for example, as an instance of the familiar Document Object Model (DOM), may be prohibitively expensive in both time and memory. For large documents, XML processing may fail due to the large memory requirements of the document. In main-memory XML processors, one of the primary sources of overhead is the cost of constructing and manipulating main-memory representations of XML documents.

Alternatives to parsing the entire document include solutions known to those of skill in the art, such as using a Simple API for XML (SAX). SAX is an example of an event-based object model for parsing XML documents. Many applications, however, are difficult to develop applications using SAX's event-based framework. The explicit construction of an in-memory tree using a framework such as DOM can simplify application development, but can have high performance overhead. Even when an application uses only a small portion of the document, the application must pay the cost of constructing the entire tree in memory. It is, therefore, important to have a mechanism by which an application developer can write an application assuming a framework such as DOM, but construct the tree representation of an XML document lazily in memory in response to accesses by the application. Rather than constructing the tree entirely in memory, the mechanism would create a “virtual” DOM where only small portions of the XML document are instantiated in memory. When a program accesses portions that have not been instantiated, the underlying mechanism would instantiate them dynamically in response to the requests. In this manner, applications can be developed easily using a framework such as DOM, while the implementation is efficient because only relevant portions of XML documents are actually instantiated in memory.

In many circumstances, an XML document is read in, processed and then sent to another destination. The conversion of an in-memory representation of an XML document into a series of bytes that can be transmitted to another process is called serialization. Serialization can be an expensive operation—the entire tree corresponding to a document must be navigated and emitted as a series of bytes. Because the serialization of XML documents is a common operation, it is important to ensure that it performs as well as possible.

### SUMMARY OF THE INVENTION

Briefly, according to an embodiment of the invention, a method, information processing system, and computer readable medium for improved representation of hierarchical documents, particularly a document encoded in Extended Markup Language (XML), where a hierarchical document and stored into an addressable data structure such as a byte array, and portions of the documents are instantiated as a tree from the byte array in response to requests by an application or program.

An XML document is read and parsed into a byte array, which is generally a more concise representation of data than a tree representation. When requests for portions of a tree, for example using XPath queries, are received by an application, the system verifies whether the portion of the tree corresponding to the tree has already been expanded. If not, the byte array is then parsed and only those nodes relevant to the request of query are expanded into a tree representation. The system continues to process requests for navigation, expanding elements as necessary, assuring that each navigation produces an identical result as evaluating the request against the original hierarchical document.

When a document is serialized, the system uses the byte array to efficiently emit the series of bytes corresponding to the document. If portions of the document are modified, the unmodified portions are emitted using the byte array. Modified portions are emitted using traditional serialization mechanisms—traversing the modified portions and emitting the bytes corresponding to them.

The subject matter, which is regarded as the invention, is particularly pointed out and distinctly claimed in the claims at the conclusion of the specification. The foregoing and other features, and also the advantages of the invention, will be apparent from the following detailed description taken in conjunction with the accompanying drawings. Additionally, the left-most digit of a reference number identifies the drawing in which the reference number first appears.

### BRIEF DESCRIPTION OF THE DRAWINGS

FIG. 1 illustrates a tree representation of an XML document in one embodiment of the present invention.

FIG. 2 illustrates a possible system architecture for a system embodying the present invention.

FIG. 3 illustrates a representation of the XML document of FIG. 1 showing materialized and inflatable nodes, in one embodiment of the present invention.

FIG. 4 is a high level block diagram showing an information processing system useful for implementing an embodiment of the present invention.

### DETAILED DESCRIPTION

We describe a method, computer readable medium, and information processing system for querying of hierarchical documents, such as documents encoded in Extended Markup Language (XML). We use a compact representation for XML documents that we call an inflatable tree. The basis of this representation is the observation that the binary representation of XML as a sequence of bytes can be five times more concise than the DOM (Document Object Model) or XQuery data model representation of XML. The representation of the present invention initially stores the bytes corresponding to the XML document in a byte array (“inflatable tree”). It dynamically builds a projection of the XML document in response to XPath expressions issued by a query processor. The inflatable tree representation enables efficient serialization of results to clients since the portions of the results that correspond to parts of the input document can be serialized directly from the byte array.

The inflatable tree representation substantially reduces the construction and serialization time in query processing. For certain queries that involve traversals of the entire tree (such as the descendant axes), query evaluation time will be improved as well. Furthermore, the inflatable tree representation allows a query processor to handle larger documents than it might otherwise (approximately, twenty-five (25) times the corresponding DOM representation).

### System Architecture

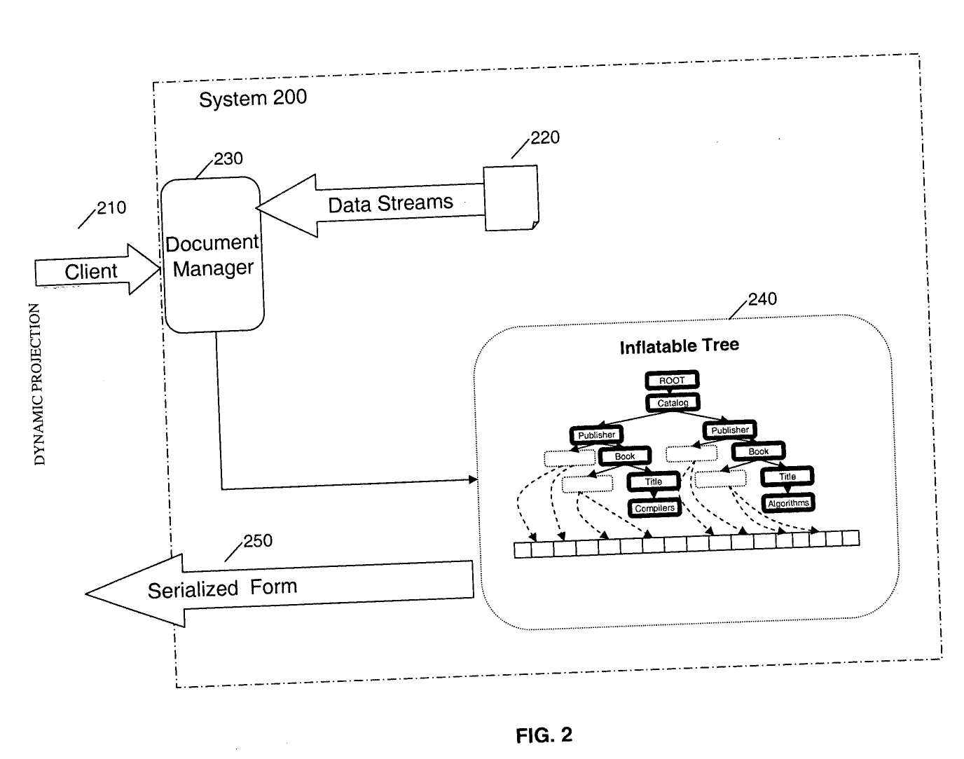

The architecture of a system 200 using an embodiment of the invention is depicted in FIG. 2. A client 210 loads a document 220 (or set of documents) by issuing a request to the Document Manager 230. A reference to the root of the inflatable tree representation 240 of the document 220 is returned to the client. The client 210 then processes the inflatable tree representation 240, and may issue further requests (for example, XPath queries) to the Document Manager 230. In response, the Document Manager 230 may expand portions of the inflatable tree representation 240 to return nodes in the tree corresponding to the request by the client. Eventually, the client may request a serialization 260 of the XML document into a byte form so that it may send the XML document to another processor.

The following describes the tree representation of the present invention and how the client interacts with it in greater detail. For simplicity, the description focuses on XML elements, though one of ordinary skill in the art will be aware that the implementation can also handle the other XML nodes, such as attribute nodes.

### Inflatable Trees

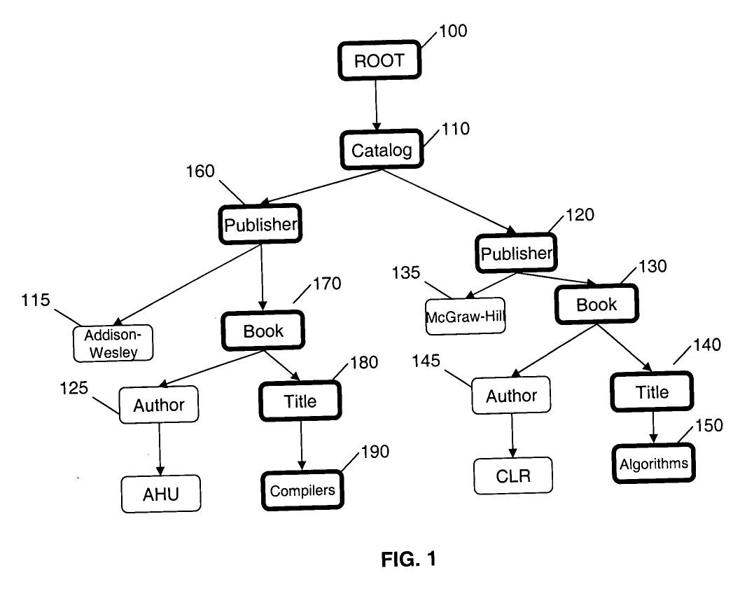

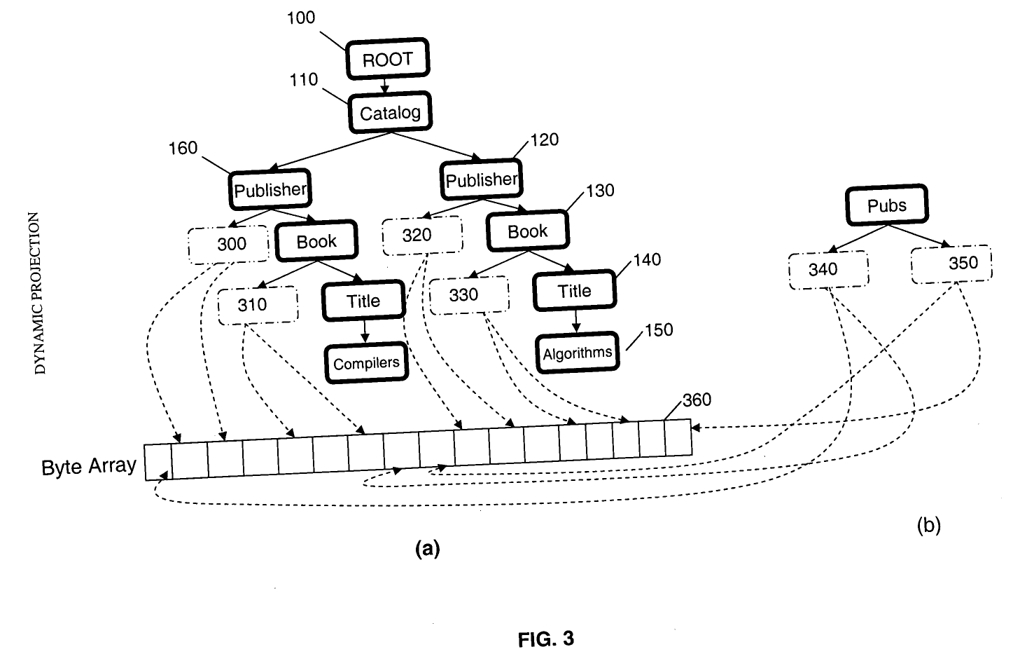

Our representation of XML documents, an inflatable tree, is based on the observation that the binary representation of an XML document (as a sequence of bytes) can be 4-5 times more concise than constructing an XQuery or DOM (Document Object Model) model instance of the document. Given a reference to an XML document, we store the sequence of bytes corresponding to the XML document in an array of bytes in memory. Our representation of the XML document in memory consists of two sorts of nodes: materialized nodes and inflatable nodes. A materialized node corresponds to an element in the document and contains all information relevant to the element, such as its tag and its unique identifier. An inflatable node represents an unexpanded portion of the XML document; it contains a pair of offsets into the byte array representation of the document corresponding to the start and end of the unexpanded portion. FIG. 3(a) depicts the inflatable tree representation of the XML document tree in FIG. 1. The highlighted nodes in FIG. 1 are materialized nodes (100, 110, 120, 130, 140, 150, 160, 170, 180, and 190) in FIG. 3(a). The nodes in FIG. 3 that have a dashed border (300, 310, 320, 330) are inflatable nodes. Inflatable nodes contain start and end offsets into the binary array of bytes of the XML document. We will also store offsets with materialized nodes corresponding to the start and end offsets of the subtree rooted at that materialized element. The start offset of an element can be used as the unique identifier for that element.

### Construction of XML

All new XML elements that the client 210 wishes to construct are constructed as materialized nodes. When, however, construction refers to subtrees from input documents, the Document Manager 230 may construct an inflatable node with the appropriate offsets. For example, consider the evaluation of the following XQuery on the document of FIG. 1.

### Pubs> for $a in //Publisher return $a </Pubs>

FIG. 3(b) shows the result of constructing the result of this XQuery expression. The constructed tree contains inflatable nodes 340 and 350 that refer to the appropriate portions of the input document.

An update to an inflatable tree is treated similarly. The new update tree is stored as in materialized form.

### Serialization of Results

Since the byte array representation of the input XML documents is retained in memory, portions of the results that are derived from the input document can be serialized directly from the byte array. This direct serialization can be substantially more efficient than explicit traversal of a tree to perform serialization. For example, in FIG. 3(b), the inflatable nodes 340 and 350 corresponding to the Pubs elements can be serialized directly from input document byte array 360.

### Deflation

At certain points, either the client or the system can recognize that an inflated portion of the inflatable tree can be deflated, that is, the tree representation can be converted back into a byte array representation. The system will process the corresponding portions of the inflatable tree and emit the bytes into a binary array and replace the appropriate materialized nodes with inflatable nodes. In this way, the system can control the amount of memory used by an inflatable tree.

### Implementing Embodiments

The system 200 may be implemented using a custom parser to generate the start and end element events corresponding to a depth-first traversal of a document. A key characteristic of the parser is the ability to support controlled parsing over a byte array—we can specify the start and end offsets of the byte array that the parser should use as the basis for parsing. This property is essential for the parsing of subtrees corresponding to inflatable nodes. Another feature of the parser is that at element event handlers, it provides offset information rather than materializing data as SAX does. For example, rather than constructing a string representation of the element tag's name, it returns an offset into the array and a length.

An embodiment of the present invention is implemented in Java, using the Xerces DOM representation as the underlying representation for the inflatable tree. Materialized nodes are represented as normal DOM nodes. Inflatable nodes have a special tag “_INFLATABLE_” and they contain two attributes indicating the start and end offsets in the byte representation of the document. The ability to use of DOM as our underlying representation is a key advantage—we are able to run DOM-based XPath parsers as is on our inflatable trees.

The presence of the byte array corresponding to the document allows for a drastic reduction in the size of the in memory representation, which in turn, reduces construction time. Furthermore, the cost of serialization reduces by a factor of four. The serialization of XML from a data model instance can be slow since the serializer must traverse the entire DOM instance and output the appropriate XML constructs. The byte array allows the serialization mechanism of the present invention to avoid this cost.

### Computer Implementation

Embodiments of the invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

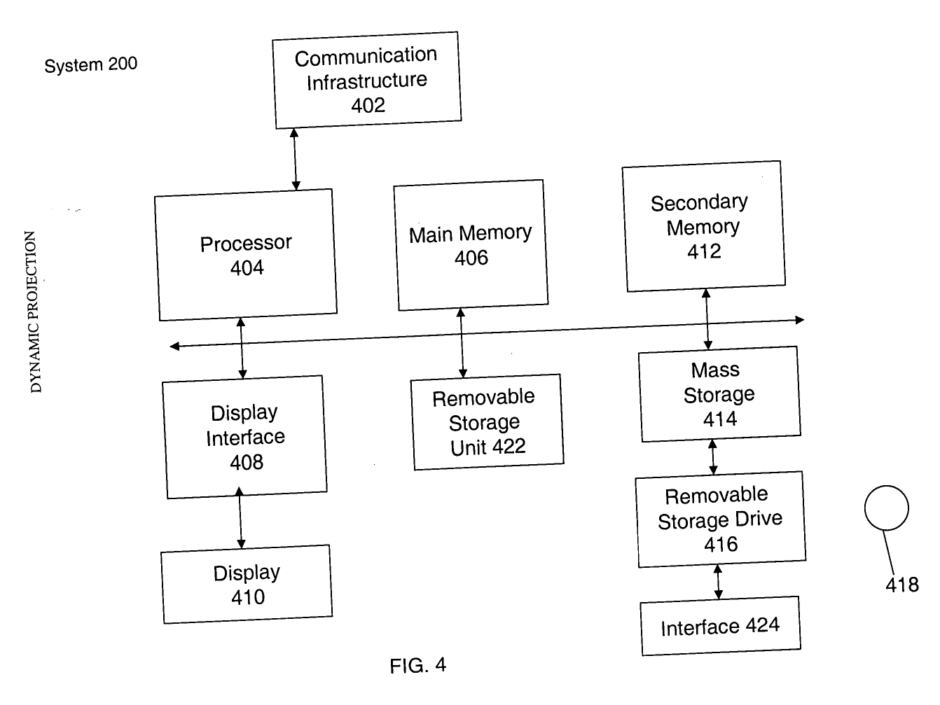

FIG. 4 is a high level block diagram showing an information processing system useful for implementing one embodiment of the present invention. The computer system includes one or more processors, such as processor 404. The processor 404 is connected to a communication infrastructure 402 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 408 that forwards graphics, text, and other data from the communication infrastructure 402 (or from a frame buffer not shown) for display on the display unit 410. The computer system also includes a main memory 406, preferably random access memory (RAM), and may also include a secondary memory 412. The secondary memory 412 may include, for example, a hard disk drive 414 and/or a removable storage drive 416, representing a floppy disk drive, a magnetic tape drive, an optical disk drive, etc. The removable storage drive 416 reads from and/or writes to a removable storage unit 418 in a manner well known to those having ordinary skill in the art. Removable storage unit 418, represents a floppy disk, a compact disc, magnetic tape, optical disk, etc. which is read by and written to by removable storage drive 416. As will be appreciated, the removable storage unit 418 includes a computer readable medium having stored therein computer software and/or data.

In alternative embodiments, the secondary memory 412 may include other similar devices for allowing computer programs or other instructions to be loaded into the computer system. Such devices may include, for example, a removable storage unit 422 and an interface 420. Examples of such may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to the computer system.

The computer system may also include a communications interface 424. Communications interface 424 allows software and data to be transferred between the computer system and external devices. Examples of communications interface 424 may include a modem, a network interface (such as an Ethernet card), a communications port, a PCMCIA slot and card, etc. Software and data transferred via communications interface 424 are in the form of signals which may be, for example, electronic, electromagnetic, optical, or other signals capable of being received by communications interface 424. These signals are provided to communications interface 424 via a communications path (i.e., channel) 426. This channel 426 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 406 and secondary memory 412, removable storage media 418, a hard disk installed in hard disk drive 414, and signals. These computer program products are means for providing software to the computer system. The computer readable medium allows the computer system to read data, instructions, messages or message packets, and other computer readable information from the computer readable medium.

Computer programs (also called computer control logic) are stored in main memory 406 and/or secondary memory 412. Computer programs may also be received via communications interface 424. Such computer programs, when executed, enable the computer system to perform the features of the present invention as discussed herein. In particular, the computer programs, when executed, enable the processor 404 to perform the features of the computer system. Accordingly, such computer programs represent controllers of the computer system.

What has been shown and discussed is a highly-simplified depiction of a programmable computer apparatus. Those skilled in the art will appreciate that other low-level components and connections are required in any practical application of a computer apparatus.

Therefore, while there has been described what is presently considered to be the preferred embodiment, it will be understood by those skilled in the art that other modifications can be made within the spirit of the invention.

1. A computerized method of representing a hierarchical document comprising steps of:
loading the hierarchical document into an addressable data structure; and
navigating the hierarchical document;
wherein the navigating step comprises further steps of:
materializing nodes of the document relevant to the navigation from the addressable data structure in memory; and
retaining links to appropriate portions of the addressable data structure for unmaterialized portions of the document.

2. The method of claim 1 wherein the step of loading a hierarchical document comprises loading an XML document.

3. The method of claim 1 wherein the navigating step is done responsive to an XPath query.

4. The method of claim 3 wherein the XPath query comprises predicate axes.

5. The method of claim 3 wherein the XPath query comprises complex axes.

6. The method of claim 1 wherein a materialization prunes unnecessary portions of the document based on the navigation.

7. The method of claim 1 wherein the addressable data structure is a byte array.

8. The method of claim 1 wherein materializing a node in the document corresponds to creating an in-memory representation of the node and all of its ancestors in the hierarchical document.

9. The method of claim 1 wherein the navigation may specify nodes to be updated.

10. The method of claim 9 wherein an update includes inserting trees into specific portions of the hierarchical document.

11. The method of claim 1 wherein a client can construct materialized nodes.

12. The method of claim 1 further comprising serializing the in-memory representation of a document into bytes using the addressable data structure.

13. The method of claim 9 further comprising serializing unmodified portions using the addressable data structure and modified portions using the materialized representations.

14. The method of claim I further comprising determining whether materialized nodes are required and deleting materialized nodes when it is determined that materialized nodes are no longer required.

15. An information processing system for querying a hierarchical document, the system comprising:
a processor configured for loading the hierarchical document into an addressable data structure; and for navigating the hierarchical document;
wherein the processor is further configured for:
materializing nodes of the document relevant to the navigation from the addressable data structure in memory; and
retaining links to appropriate portions of the addressable data structure for unmaterialized portions of the document.

16. The information processing system of claim 15, wherein the hierarchical document is in the XML format.

17. The information processing system of claim 15, wherein the query is in the XPath query language.

18. The information processing system of claim 15, wherein XPath query comprises predicate axes.

19. The information processing system of claim 15, wherein the XPath query comprises complex axes.

20. The information processing system of claim 15, wherein a materialization prunes unnecessary portions of the document based on the navigation.

21. The information processing system of claim 15, wherein the addressable data structure is a byte array.

22. The information processing system of claim 15, wherein materializing a node in the document corresponds to creating an in-memory representation of the node and all of its ancestors in the hierarchical document.

23. The information processing system of claim 15, wherein the navigation may specify nodes to be updated.

24. The information processing system of claim 15, wherein an update includes inserting trees into specific portions of the hierarchical document.

25. The information processing system of claim 15, wherein a client can construct materialized nodes.

26. The information processing system of claim 15, wherein the processor is further configured for serializing the in-memory representation of a document into bytes using the addressable data structure.

27. The information processing system of claim 15, wherein the processor is further configured for serializing unmodified portions using the addressable data structure and modified portions using the materialized representations.

28. The information processing system of claim 15, wherein the processor is further configured for determining whether materialized nodes are required and deleting materialized nodes when it is determined that materialized nodes are no longer required.

29. A computer readable medium comprising instructions for:
loading a hierarchical document into an addressable data structure; and
navigating the hierarchical document;
wherein the navigating instruction comprises further instructions for:
materializing nodes of the document relevant to the navigation from the addressable data structure in memory; and
retaining links to appropriate portions of the addressable data structure for unmaterialized portions of the document.
